(19) United States
(12) Patent Application Publication
(10) Pub. No.: US 2009/0065583 A1
(43) Pub. Date: Mar. 12, 2009

(54) RETRO-EMISSIVE MARKINGS

(76) Inventor: Stephen P. McGrew, Spokane, WA (US)

Correspondence Address: PERKINS COIE LLP;PATENT-SEA, P.O. BOX 1247, SEATTLE, WA, 98111-1247, US

(21) Appl. No.: 11/817,974

(22) PCT Filed: Mar. 10, 2006
(86) PCT No.: PCT/US2006/008939

§ 371 Date: Apr. 14, 2008

Related U.S. Application Data
(60) Provisional application No. 60/660,686, filed on Mar. 11, 2005.

(51) Int. Cl. G06K 7/10; G06K 19/06; B05D 5/06; G01J 3/30

(52) U.S. Cl. 235/454; 235/491; 356/317; 427/163.4

(57) ABSTRACT

A retro-emissive marking system that returns a coded-spectrum optical signal to a source of an interrogation beam is described. The system is valuable for applications such track-and-trace systems, vehicle markings, anti-counterfeit/security, inventory control, animal ear tags, product authentication, identification cards, and security systems; and it also has value as a remotely readable sensor of chemical or biological agents.

### CROSS REFERENCE TO RELATED APPLICATION(S)

This application claims priority to U.S. Provisional Application No. 60/660,686, filed Mar. 11, 2005, entitled RETRO-EMISSIVE MARKINGS, which is hereby incorporated by reference in its entirety.

### BACKGROUND

A retroreflector reflects light that originates at an outside light source. In some cases, adding fluorescent elements to the material of the reflector results in devices that are retroreflective at night and fluorescent in the daytime. For example, in a corner-cube retroreflector, any fluorescent light emitted by the bulk of the material is emitted in all directions regardless of the direction of incidence of the excitation light, so the fluorescence in that type of retroreflector does not have the directionality that makes retroreflectors useful. In some cases, ordinary pigmented glass or plastic is used in the bulk material of retroreflectors to provide a colored return beam, such as in the red corner-cube retroreflectors used on most automobiles.

Cat's eye type retroreflectors have also been used. In a cat's eye retroreflector (e.g. as shown in FIG. 1A), a lens 105 in a lens array 127 focuses incident light 100 onto a point 110 at reflective surface 115. Reflected light from that point is essentially an expanding spherical wave that the lens 105 subsequently converts to a collimated beam 125 directed back to the illumination source. When the reflective surface 115 is roughened to make it a diffuse reflector, it still works essentially the same, because the diffusely reflected light still has the form of a wave expanding from a small point 110 on the surface. Since the surface 115 is at the focal plane of the lens, the lens 105 collimates light emerging from the point 115 on the surface. FIGS. 1B and 1C illustrate alternative cat's eye retroreflector structures, exhibiting similar functionalities as that of FIG. 1A: each lenslet focuses incident light to a reflective surface which returns light back through the lenslet into a path antiparallel to the incident light. FIG. 1B illustrates a glass bead retroreflector in which the front surface of each bead focuses incident light to a point on the back surface of the bead, where the focused incident light is then reflected to pass back through the front surface of the bead and return to the light source. FIG. 1C illustrates a prior-art cast plastic device analogous to the glass bead retroreflector.

Retroreflective devices provide strong return beams upon interrogation by a light beam, because they reflect incident light directly back toward the source. For example, colored highway signs and retroreflective tags on trucks and railroad cars work by absorbing unwanted portions of the incident spectrum and retroreflecting the remainder of the spectrum back toward the illumination source.

Also, fluorescent tags have been used to provide a wide range of color choices and can be excited by invisible ultraviolet light to provide a spectrally encoded signature. However, fluorescent tags emit light uniformly in all directions. As a result, the brightness of a return signal at a substantial distance from a simple fluorescent tag is several orders of magnitude below that of retroreflected light. If fluorescent material is simply added to the lens material of a retroreflective tag, the fluorescent light is still emitted in all directions and does not provide a strong fluorescent signal back toward the illumination source.

### BRIEF DESCRIPTION OF THE DRAWINGS

FIG. 1A illustrates a prior art cat's eye retroreflector, in the form of an array of lenses with a reflective surface in the back focal plane of the lenses.

FIG. 1B illustrates another prior art cat's eye retroreflector, in the form of a random or regular array of glass spheres, aluminized on the back surface.

FIG. 1C illustrates a prior art cat's eye retroreflector in the form of an array of biconvex lenses cast in plastic, with reflective material on the back surfaces of the lenses.

FIG. 2A illustrates an embodiment of the present invention, a retro-emissive device comprising a cast lenslet array in which the focal surface is the back surface of the lenslets, and the focal surface is coated with quantum dots or other materials that emit light of one spectral content when stimulated by light of another spectral content.

FIG. 2B illustrates another embodiment of the present invention, comprising a lenslet array whose lenses are one focal length away from a fluorescent surface.

FIG. 3 illustrates another embodiment of the present invention, in which glass spheres are coated on their backs with light emissive material and are embedded in a resin layer on a substrate to form a retro-emissive tag or marking.

FIG. 4 illustrates a system for making coded retroemissive tags on a roll-to-roll web basis, comprising several print heads positioned to apply fixed or variable patterns of fluorescent inks onto the focal surfaces of a lens array carried on a web.

FIG. 5 represents a random or regular array of randomly oriented high-value glass beads half-coated with a light emissive substance.

FIG. 6 illustrates a retro emissive spatial or spectral barcode, comprising a lenslet array with a pattern of light emissive material in the focal surface of the array.

FIG. 7 represents a lenslet array with a repetitive pattern of light emissive or color-selective material in the focal plane of the array, the whole structure serving as a 1-dimensional or 2-dimensional angle-indicating retroemissive device.

FIG. 8 represents a two-dimensional angle-indicating retroemissive device comprising a lenslet array and a corresponding array of substantially identical light emissive or color-selective patterns, each pattern itself comprising a region of light emissive materials whose spectral properties vary according to their positions within each region.

FIG. 9 is a schematic representation of a reader for retroemissive devices, the reader including a light source, a telescopic optical system, a spectrometer, and a computer (not shown) to analyze a received spectrum from a retroemissive device.

FIG. 10A is a flow-through retroemissive detector of chemical or biological agents. The retroemitted spectrum of the detector is affected by the presence or absence of the agents, allowing remote reading of the detector.

FIG. 10B is also a flow-through retroemissive detector of chemical or biological agents.

FIG. 10C is a retroemissive detector of chemical or biological agents, the detector having the form of a glass or plastic bead coated in one hemisphere with a light emissive layer whose optical properties are a function of the local concentration or concentration history of a particular type of chemical or biological agent in the vicinity of the bead.

FIG. 10D is a remotely readable retroemissive detector of chemical or biological substances, the detector having the form of a cast lens array, the back surface of which is the focal surface, coated with a retroemissive material whose emissive properties are affected by the presence of a specific chemical or biological substance.

FIG. 11 illustrates a variation on the principle of the substance detectors in FIGS. 10A, 10B and 10C. Instead of having only a light-emissive material coated on its focal surface 1640, the focal surface is coated with a substance having a binding affinity to a target substance.

FIG. 12 illustrates another example of a detector or reader of retro-emissive and retro-reflective devices.

FIG. 13 illustrates a retroemissive tag reader that performs a similar function to the one in FIG. 12, where in addition, spectral information is detected by filtering incoming retroemitted light through a variable narrow-bandpass wavelength filter.

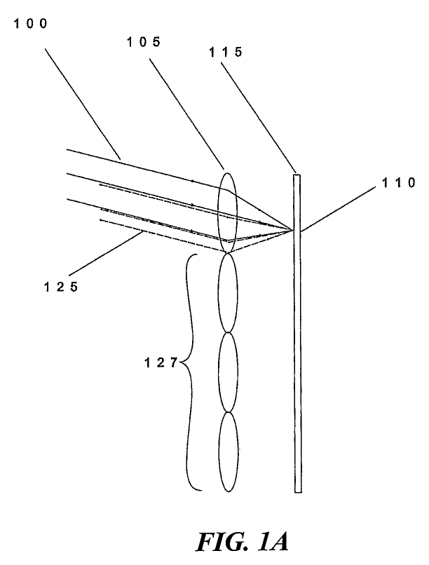

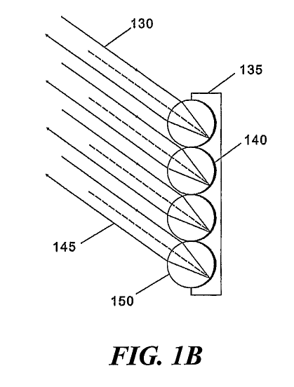

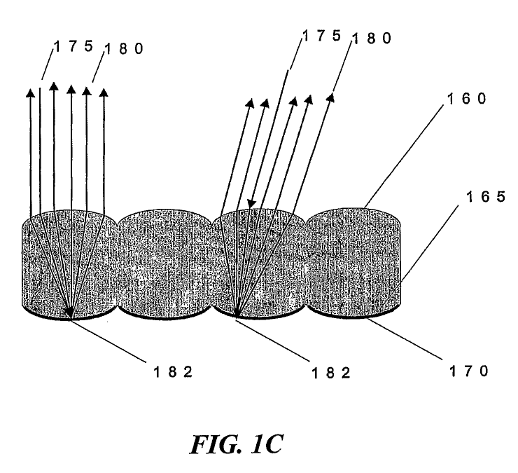

### DETAILED DESCRIPTION

Embodiments of the technology are directed to a “retroemissive device”: a device that responds to incident light by emitting light back toward the source of the incident light, the emitted light having a spectrum that is different from that of the incident light. Retroemissive devices provide low cost and high signal strength while providing spectral coding capabilities like those of fluorescent tags, resulting in a high information content marking that can be read at close or far distances, such as distances ranging from a few millimeters to hundreds of meters. In some cases, the technology involve retro-emissive tags and a line-of-sight system for reading the tags. Retro-emissive tags make use optical geometry similar to the geometry in “cat's eye” retro-reflectors. However, instead of retro-reflecting light back to a source, a retro-emissive tag emits light when illuminated by light from an external source and directs the emitted light toward the source. Light emitted from the retro-emissive tag is spectrally different from the incident light, and has an internal source activated by the focused incident light. The emitted light can be, for example, fluorescent light that is emitted by a material when the material is illuminated by the illumination light. Alternatively, the emitted light can be upconverted light excited by multi-photon absorption of the illumination light, Stokes or anti-Stokes emission, and so on.

The technology will now be described with respect to various embodiments. The following description provides specific details for a thorough understanding of, and enabling description for, these embodiments of the invention. However, one skilled in the art will understand that the invention may be practiced without these details. In other instances, well-known structures and functions have not been shown or described in detail to avoid unnecessarily obscuring the description of the embodiments of the invention.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

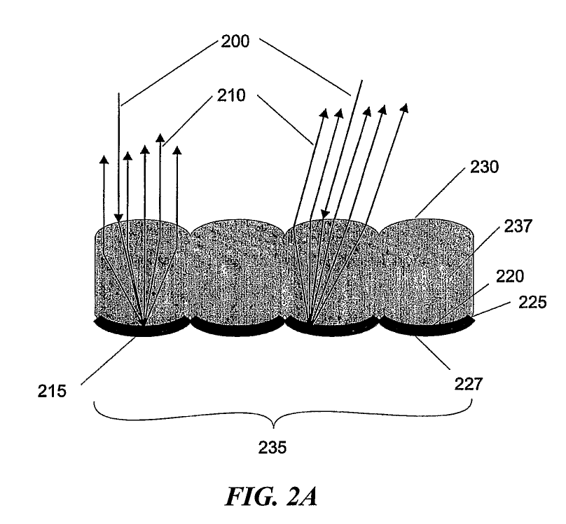

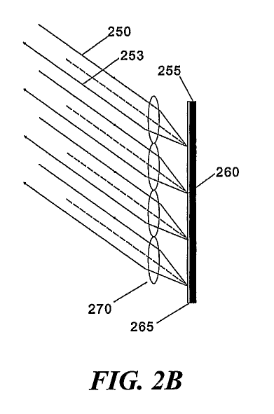

As an example of some embodiments of the technology, a UV-cast lens array 235 is formed as illustrated in FIG. 2A. A spherical lenslet 230 has a spherically curved back focal surface 220. In this example, the back focal surface 220 is coated with a layer 225 of fluorescent CdSe quantum dots in a resin binder having a certain refractive index (e.g., in the range from 1.3 to 2.1). Preferably, although not necessarily, the refractive index of the resin binder should be the same as or higher than that of the UV-cast resin.

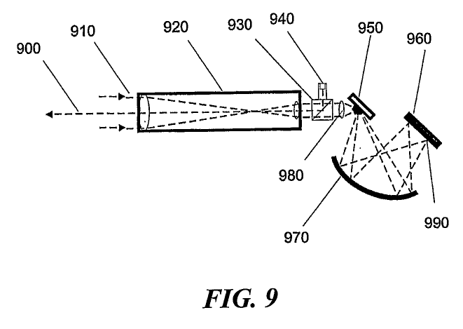

The sizes of the quantum dots in the layer 225 are selected to provide a certain fluorescent emission spectrum. Such quantum dots may be obtained commercially in the United States, from any of several suppliers. An ultraviolet light source (e.g., an LED with an emission wavelength of 365 nanometers with a parabolic reflector to collimate its beam) serves as the interrogation source, although any bright light source that emits light at a wavelength sufficiently shorter than the fluorescent emission wavelength of the quantum dots to stimulate fluorescence can serve as the interrogation source. Light 200 from the interrogation source is directed at the lens array 235 where the light is focused by refraction at the front surface (e.g., 230) to converge to a point (e.g., 215) on the back focal surface (e.g., 220) of each lenslet in the array 235. The interrogation light 200 induces fluorescence in quantum dots in layer 225, and fluorescent light 210 emitted by the quantum dots in layer 225 in turn passes through the bulk of the lens material 237 and is collimated by refraction at the front surface 230 into a nearly collimated beam 210 that is directed back at the interrogation light source. A reflective layer 227 can substantially increase the brightness of retro-emission (e.g., by as much as a factor of four). Each lenslet in the lens array 235 performs the same operation in response to incident light 200 from the source (source not shown), contributing a share of retro-emitted light to the return beam 210. At the interrogation source location, a light-gathering optical system such as that illustrated in FIG. 9 (discussed in detail below) captures the retro-emitted light 910 and spreads the light into a spectrum. A photodiode array or imaging photomultiplier may measure the light intensity at each of several optical wavelengths. A computer interprets the code represented by the light intensities corresponding to the several optical wavelengths.

In addition to spectral coding as described above in which the retro-emissive layer's spectral emission properties are selected to represent information, it is also possible to take advantage of varying fluorescence decay times of different fluorophores to add a second dimension of encoding, increasing the available data content of the returned signal substantially. For example, lead sulfide quantum dots and cadmium selenide quantum dots of appropriate sizes have the same emission peak but distinctly different fluorescence lifetimes. By modulating the interrogation light at several frequencies, such as ranging from 20 megahertz to 200 kilohertz, then analyzing the brightness and timing of the retroemitted return light from a retroemissive device, the ratio of a mixture of the two types of quantum dots in the retroemissive device can be calculated.

An example of an alternative embodiment of the technology, illustrated in FIG. 2B, employs a lenslet array 270 and a separate surface 255 bearing a coating 265 of light emissive material such as ZnS-capped CdSe quantum dots. The separate surface 255 is placed one focal length away from the lenslet array 270 so that collimated light 250 incident on each lenslet in the array 270 is focused to a corresponding point (e.g., 260) on the light emissive material coating 265.

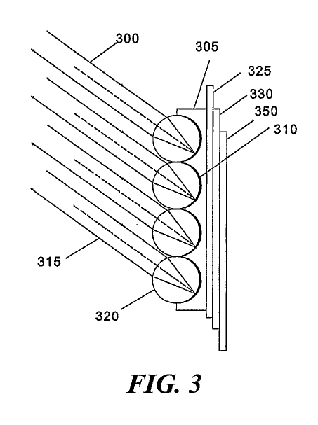

An example of an additional embodiment of the technology, illustrated in FIG. 3, uses spherical glass beads similar to those in retroreflective highway signs. The Figure shows glass beads 320, resin layer 305, substrate 325, adhesive layer 330, and peel-off paper 350. The beads 320 (typical) are coated with a retro-emissive material on their back surfaces with a portion (e.g., 60%) of each bead being buried in a resin 305 and the remainder of each bead protruding above the resin surface. The resin adheres to a carrier film 325, and the carrier film is coated with an adhesive 330 and laminated with a silicone-coated peel-off paper 325. The structure is then diecut and converted to adhesive tags. Interrogation light 300 is focused onto retro-emissive layer 310 on the back of the beads 320, generating retro-emitted light which is returned toward the source of interrogation beam 300 as a beam 315. The light emissive material in this and other embodiments may be formulated as a mixture of several types of different fluorescent materials, quantum dots, upconversion materials, Raman-emissive materials, Stokes or anti-Stokes emitters and so on with different emission spectra to produce an identifiable composite fluorescence spectrum.

The term “upconversion” as used herein refers to any process by which light is absorbed by a material at one wavelength and subsequently emitted at a shorter wavelength. Upconversion has at least two time parameters. It is a multi-photon process in that at least two photons must be absorbed to provide sufficient energy for a shorter-wavelength photon to be emitted. After absorption of the first photon, the upconversion particle is in a first excited state; then absorption of a second particle raises the particle to a second excited state; decay of the second excited state produces the shorter-wavelength photon. If the first excited state decays before a second photon is absorbed, the upconversion process does not occur unless a third photon arrives and is absorbed soon enough after the second photon is absorbed. Thus, if the lifetime of the first excited state is short, upconversion occurs only very rarely unless the intensity of the illumination is very high. Accordingly, upconversion materials are most easily activated and detected by a pulsed laser beam. The lifetime of the first state correlates to the upconversion efficiency versus illumination intensity, and the lifetime of the second state correlates to the duration of the upconverted emission following an excitation pulse.

An example of another embodiment of the technology (also illustrated in FIG. 3) uses a multilayer dielectric color-selective reflective film 310 instead of a fluorescent material applied to the back surface of the retroreflective beads (e.g., 320) or to the focal surface of a lenslet array, such that the spectral retroreflectivity of the device is determined by the properties of the reflective film 310.

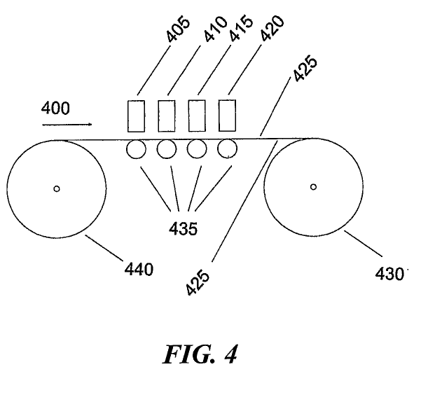

An example of another embodiment of the technology, illustrated in FIG. 4, uses several different print heads 405, 410, 415, 420 to print fluorescent, upconversion or other retroemissive materials on the back surfaces (in the Figure, the upper surfaces) of spherical glass beads carried by a releasable adhesive on the upper surface 425 of a carrier film. The retroemissive materials are printed in a pattern such as a bar code, so that each part of the pattern retro-emits a predetermined spectrum of light. A retro-emissive tag can be made from that structure by subsequently covering the beads with a binding resin (305 in FIG. 3) and laminating a second carrier film onto the cured resin. The first carrier film can then be removed, thereby revealing the uncoated portions of the surfaces of the beads. When scanned by an interrogation beam approximately the size of (or smaller than) the smallest features in the tag pattern retro-emits a spatial or angular pattern of light containing both spectral and spatial information. Spectral information corresponds to the mixture of fluorophores in the fluorescent material at each point in the focal surfaces of the beads in the structure. When an entire retro-emissive tag comprising an array of such beads or lenslets each with its respective retro-emissive coating is illuminated by an interrogation beam large enough to cover the entire tag, the spectral content of the return beam is determined by the properties and the amounts of the materials in the entire tag. Thus, for a tag intended to be read from a great distance such that the interrogation beam is spread out over the whole tag, the effective retro-emissive spectrum of the entire tag may be predetermined by simply printing predetermined amounts of various types of light emissive materials in different regions of the tag. However, when the same tag is read from nearby using a small-diameter interrogation beam or an imaging spectrum analyzer, the spatial distribution of spectral properties across the tag can also be read, thereby providing an increased amount of information. The processes of printing, covering and laminating can be done on a continuous roll (440) to roll (430) basis. Items 435 are support rollers to prevent vertical motion of the film during the printing process.

The devices may use a mixture of fluorescent and upconversion materials, and can be interrogated using a light beam containing a mixture of wavelengths suited to stimulating emission from each of the different materials. Doing so enables the technology to employ an optimum stimulating wavelength that may be different for different materials.

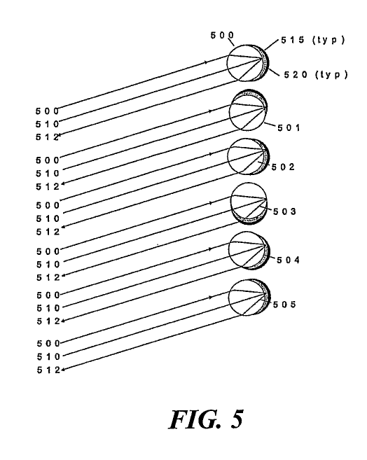

An example of another embodiment of the technology, illustrated in FIG. 5, uses glass or plastic beads (500, 501, 502, 503, 504, 505). The beads may be applied to a surface without regard to their orientation. The beads have a light-emissive coating 520 coated on one hemisphere, and may have a reflective or absorptive coating 515 applied behind the light-emissive coating. Although, in some cases, the beads could be randomly oriented and therefore not retro-emissive in all directions, a large enough fraction of them have at least a portion of their uncoated hemisphere directed generally toward incident light 500 from any interrogation source to return a measurable spectrum of retro-emitted light 512 to the source. If an absorptive coating 515 is applied over the light-emissive coating 520, light emission into directions other than back toward the illumination source will be minimized. The term “Typ” in the Figures means “typical,” i.e., being representative of the element indicated in the Figures.

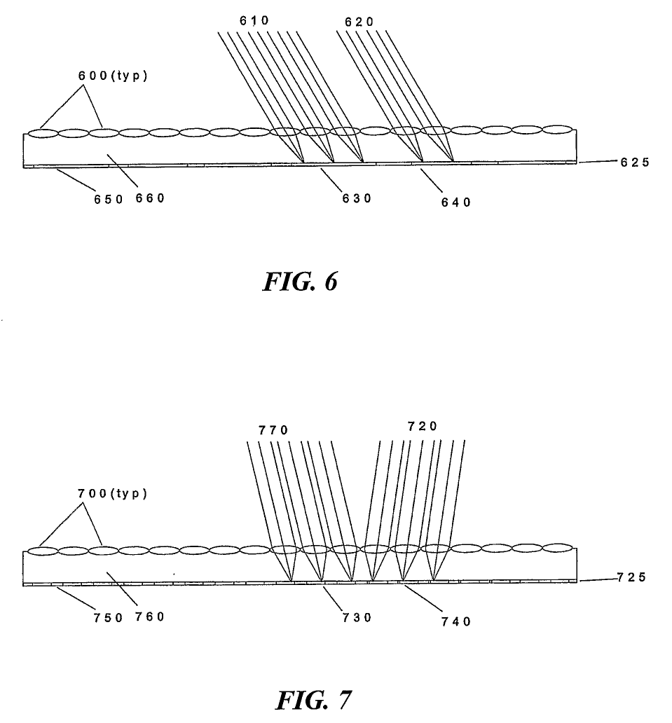

An example of another embodiment of the technology, illustrated in FIG. 6, uses a lenslet array (600 typ) placed a certain (such as one) focal length above a surface 625. A bar code (e.g., 650, 630, 640) is printed onto the surface 625 in the form of regions (650, 630, 640) of different mixtures of retroemissive materials. The regions may be at least as large as the size of one lenslet.

An example of another embodiment of the technology, illustrated in FIG. 7, uses a lenslet array (700 typ) placed approximately one focal length above a surface 725, and a repetitive pattern (e.g., 730, 740) is printed onto the surface 725, each repeating pattern preferably, although not specifically, being no larger than the size of one lenslet and registered to (i.e., located at the focal plane of and on a common axis with) a corresponding lenslet. The spectral emission properties of the retroemissive material in each pattern vary across the pattern in a one-dimensional or two-dimensional fashion. Thus, the retro-emissive tag returns a light beam whose spectral content corresponds to the angle of the tag relative to the line of sight between the light source and the tag. That is, different spectra are retro-emitted by the individual lens/pattern elements of the tag and therefore by the whole tag comprising a set of individual lens/pattern elements, depending on the angle at which the incident light strikes the tag. The distribution of retro-emissive properties in the repeating pattern therefore encodes the tag-to-line-of-sight angle as a spectral distribution in the return beam. If the repeating pattern is radially symmetric and centered under each lenslet, for example, the return beam's spectral content is independent of the angle of rotation of the tag relative to its own surface normal. If the different sections of the repeating pattern are made so that no two sections of the pattern have the same fluorophore mixture, then the return beam's spectral content encodes both the angle of the line-of-sight to the tag's surface normal, and the angle of rotation of the tag relative to its surface normal. That is, the spectral content of the return beam encodes both the pitch and yaw of the tag relative to the line-of-sight. If the tag consists of lenslets and corresponding patterns, where the patterns are one-dimensional like a barcode, then the spectral content of the return beam corresponds only to, for example, the yaw or pitch of the tag relative to the illuminating beam.

This example illustrates, for example, a way for an aircraft to determine its absolute position above a ground location by reading return signals from as few as two retroemissive devices properly placed in the vicinity of the ground location, if the locations and orientations of the two retroemissive devices are known. Retroemitted information from one device determines that the aircraft is somewhere along a certain line that intersects the device; and retroemitted information from the other device determines that the aircraft is somewhere along another line that intersects the other device. The intersection of the two lines identifies the precise location of the aircraft. If the light emissive pattern is not repetitive, the pattern may be structured to retro-emit a different image in different directions, in a manner analogous to a lenticular photograph. A large retro-emissive marking can thus display a different graphical image to an aircraft flying over, with the particular graphical image depending on the position of the aircraft relative to the retro-emissive marking.

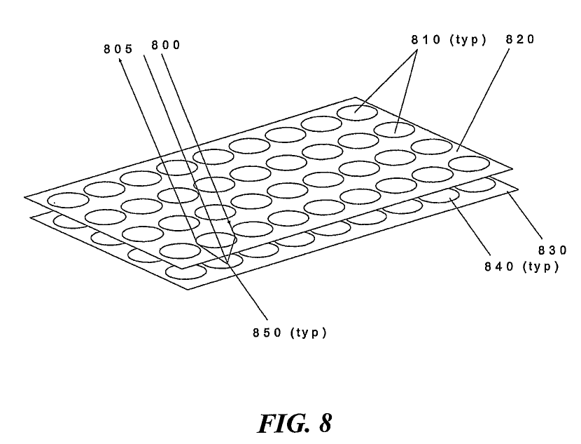

A suitably structured retroreflective or retroemissive device such as that discussed with respect to FIG. 8 can provide similar information. As a retroreflective device, absorptive pigments in a fine pattern 840 (typ) repeated in the focal plane of each lenslet absorb different components of the spectrum of the interrogation light 800 and return the remainder 805 to the interrogation source. In this case, the returned light is retroreflected, but its spectrum is controlled by the optical properties of the absorptive pigments, independently for each angle due to the pigment pattern in the focal plane of each lenslet. If the composition of the pigment is different at different points in the pattern 840, then the spectral content of the retroreflected light 805 is a representation of the azimuth and elevation of the interrogation source relative to the retroreflective device.

A retro-emissive tag offers the possibility of encoding information into a tag, based on applying materials having different combinations of optical properties (such as fluorescence, Raman spectra, Stokes or anti-Stokes emission, absorbance, reflectivity, and so on) to the retroreflective or retroemissive layer in a tag's focal plane. For example, the tag might contain a bar code, with each stripe in the bar code printed using a different mixture of 16 distinguishable fluorescent inks. By combining fluorescent materials having various fluorescence spectra and various fluorescence lifetimes, or upconversion materials with selected properties, one may encode up to 64 or more bits of information into a tag. With 64 bits of information in the tag, it is possible to distinguish a practically unlimited number of distinct tagged individuals or equipment items clustered in a small area or spread out over a wide area. This, combined with the high geometric gain of retro-emission, enables the technology to identify and locate individuals or equipment at large distances (such as a kilometer away). This capability generally removes the risk of counterfeit tags or of mistaking ordinary retroreflectors for the retro-emissive tags.

The technology can easily be adapted to anticounterfeit and product authentication applications. A straightforward adaptation of the proposed technology, such as the retroemissive bar code of FIG. 6 and a small version of the reader in FIG. 9, results in a very high data-density bar code and a scanner capable of reading as much as 6400 bits of variable information from a small label at a range of a few millimeters, to a few hundred bits at a range of several meters. This offers the possibility of a remote scanner to detect and read labels from across a room in a warehouse or retail store, from a freeway or railroad overpass, from an unmanned remotely-controlled aircraft, on a conveyor belt, and so on.

The directionality of “retro-emissive” light from a retro-emissive tag may depend on the thickness of the light emissive layer, the accuracy with which it is placed at the focal plane of the lens, and/or the size and quality of the lens. For example, with a lens width of 1 millimeter, a focal length of 1.5 millimeter and a fluorescent layer thickness of 50 microns, the retroemitted fluorescent light will be directed into a cone of about 8 degrees, providing a geometric gain of about 400. If a fluorescent coating with thickness of a few hundred nanometers and high quantum efficiency (that is, high brightness) is used, the retro-emitted light can be concentrated into a cone of one degree, leading to a geometric gain approaching 100,000. For covert marking and remote, covert detection, it is desirable for the geometric gain to be as high as possible, so in those applications the light emissive layer should be placed as accurately as possible in the focal plane of the lens and should be as thin as possible while still being thick enough to absorb a large fraction of the interrogation light and emit a useful amount of light in response. The acceptable thickness of the light emitting layer will depend on the size and power of the lens. A longer focal length lens can tolerate a greater thickness of the light emitting layer than a shorter focal length lens. Similarly, the quality of the lens affects the size of the focal spot and hence the distribution of retroemitted light. It is well within the skills of a typical optical system design engineer to calculate the distribution of retroemitted light from a retroemissive device based on the lens focal length and width, and the thickness of the light emitting layer.

If a reflective surface is provided in addition to the light emissive layer, the geometric gain of the retroemissive device will be reduced because it provides, in effect, a second light-emitting region which is the reflected image of the light emitting region of the light emissive layer. In those applications where geometric gain should be maximized, therefore, a reflective surface is not desirable. Moreover, a retroemissive device with a reflective layer near the focal plane of the light-focusing component will cause the device to be retroreflective as well as retroemissive. In many of the contemplated applications for retroemissive devices, retroreflection is not desirable so a reflective surface would not be desirable even though it might increase the brightness of the retroemitted light significantly.

Fluorescence (because it converts incident light energy to a specific spectral distribution of emitted light) provides a spectral signature that will enable a detection system to reject background ambient light, ordinary reflected light and ordinary retroreflected light, and thereby provide a high signal-to-noise ratio. For example, at a range of 100 meters, using a 5 milliwatt blue laser diode, a fluorescent coating with a quantum efficiency of 25%, a detection receiver having a lens aperture 100 millimeters in diameter, and a retrofluorescent tag with the characteristics given above, the received fluorescence signal from the retro-emissive tag can be approximately 6.3×10⁻⁹ milliwatts. A telescope (920 in FIG. 9) will focus the received light down to a spot less than 1 mm in diameter, increasing the intensity to approximately 0.26 microwatts per square centimeter, which is easily detectable by a photodiode (for example, the Burr-Brown OPT301 monolithic integrated photodiode and amplifier has a dc sensitivity of 4×10⁻¹⁰ watts).

In a search-and-rescue system, a much more powerful laser may be used in order to allow broad-area search at long range, with a focused small-area search after possible tags have been located. If a very thin high-efficiency fluorescent coating is used, the returned signal can be up to 100 times greater, allowing use of a low power diode laser.

In search and rescue applications, there are several advantages to the invention, which include, for example, brightness, noise rejection, stealth, information capacity, and so on. First, the brightness of the returned signal may be increased by a geometric gain of 100 to 100,000 (depending on the lenslet size and the thinness of the fluorescent coating). Second, because the returned signal is at a different wavelength than the excitation light, the signal will be substantially greater than the background noise both in the daytime and at night. Third, because retro-emitted light is preferentially directed back toward the excitation source, very little return light is detectable from positions other than that of the search and rescue vehicle. Fourth, retro-emission provides the opportunity to encode at least 64 bits in a tag (perhaps 6400 bits with time-resolved retrofluorescence), which will make it possible to identify individual persons and equipment items by the fluorescence signals from their tags.

An example of construction of certain embodiments of the technology is illustrated with respect to FIG. 2A. A surface is placed at the focal plane of a low f-number lens, and the surface is coated with a thin layer of fluorescent material such as lanthanide compounds or semiconductor quantum dots. In practical applications, the structure will employ a UV-cast, embossed or injection molded plastic fly's eye lens, glass spheres, or an array of discrete glass or plastic lenses. High quality lenses may provide a much stronger, and better-directed, return signal. The fluorescent material will be placed as accurately as possible in the focal plane, and should be as thin as possible while being thick enough to ensure absorption of virtually all of the incident ultraviolet light. A properly positioned thin fluorescent layer will ensure that fluorescence is excited at a very small point in the focal plane, which will in turn ensure that the lens gathers and directs the fluorescent light directly back towards the UV light source.

The design process for a specific application ideally takes into account spectral dispersion in the lens, because it is important for the focal length of the lens to be very nearly identical for the excitation wavelength and the emission wavelengths of the light-emissive materials employed, in order for the directionality of the return to be maximum, and the signal strength to be maximum at the receiver. Spectral dispersion, if uncompensated, can make the retro-emitted signal spectrum angle-dependent and result in lower useful data capacity. An advantage to injection molded or UV-cast fly's eye lens arrays like the one described in FIG. 2 is that the back surface can be shaped to compensate for non-flat focal plane. The same advantage would apply to glass spheres such as those used in the retroreflective paints on highway signs: the back surface of the sphere corresponds to the curved focal plane of light focused by the front surface.

FIG. 2 also illustrates a retro-emissive tag that can achieve good optical quality and still be inexpensive to manufacture. An ideal design requires optimization of spectral dispersion of the plastic, refractive index, shapes of the lens and focal surfaces, reflective losses at the lens surface, and directionality of the retroemitted light.

UV casting can be done using a UV embosser, such as the embosser described in U.S. Pat. No. 4,758,296, which is hereby incorporated by reference in its entirety.

As an example, FIG. 9 illustrates the principle of operation of a reader for retro-emissive tags. A 365-nm (ultraviolet) amplitude modulated diode laser 940 (for example) illuminates a retro-emissive tag through a telescope 920 with light 900. Dichroic beamsplitter 930 directs the UV light through the telescope. Retro-emitted light 910 from the tag returns to the telescope 920, passes through the beamsplitter 930 and is focused to a spectrum on photodetector array 990 via mirror 950 and concave grating 970 If the detector array 990 on mount 960 has a higher frequency response than the fluorescence half-lifetime of the retroemissive material in the retro-emissive tag, the detector array and a signal-processor (not shown) may analyze either or both the spectrum of the fluorescent light and its decay rate (fluorescence lifetime).

Fluorescence lifetime can be measured using a number of known techniques, such as by modulating the intensity of, for example, a 365-nm excitation beam at several frequencies, then detecting the modulation depth and relative phase shift of the retro-emitted signal compared to the excitation light. The detector, therefore, needs to be fast enough to track the intensity modulation, and needs to be sensitive enough to read the signal in the time during which an illumination beam illuminates the tag or a feature in the tag during a scan. The width of the beam and its scan speed determine the illumination time.

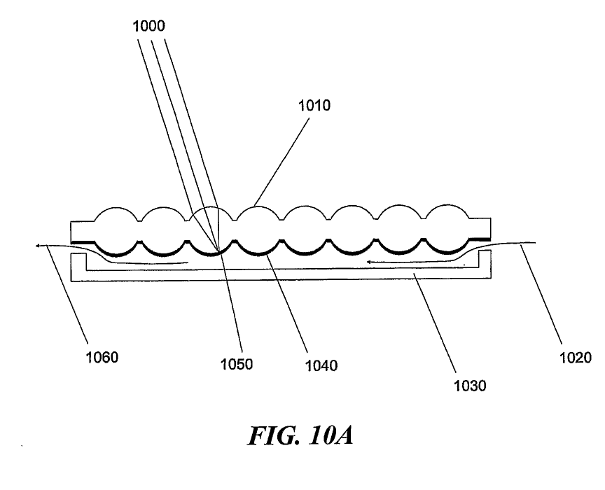

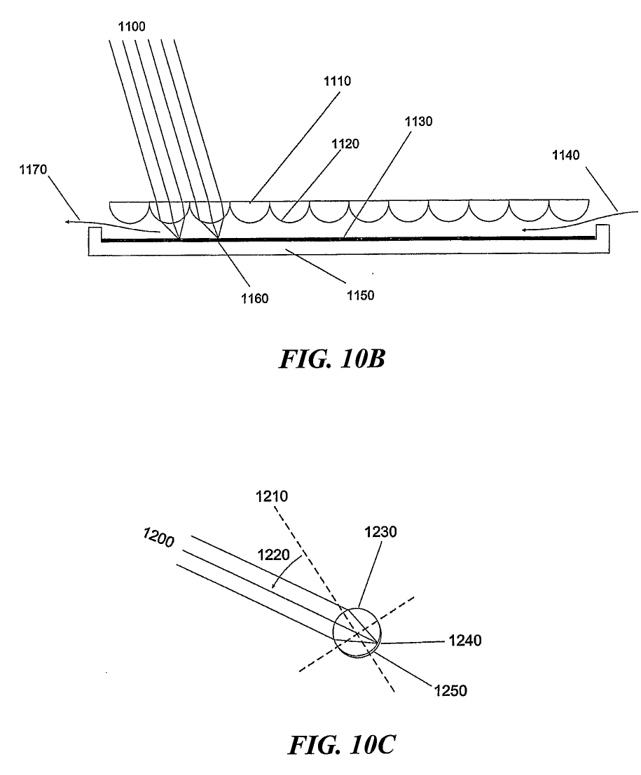

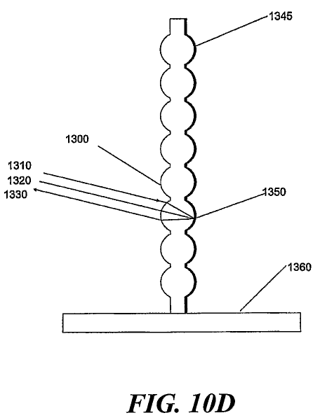

As an example, FIG. 10A illustrates an adaptation of a retroemissive tag (RE tag) useful for remote sensing of substances such as chemical and biological warfare agents. The RE tag is a cast lenslet array 1010 whose back surface is the focal surface 1040 coated with a light-emissive material selected to be sensitive to the presence of a specific chemical or biological agent, so that its retroemitted spectrum is dependent upon the presence, absence, or local concentration of the agent. For example, the coating can be a dye whose fluorescence is quenched by the presence of the agent, which can be carried into close contact to the coating via liquid or gas flow 1020, 1060 through a chamber formed between the lenslet array 1010 and a back plate 1030. The RE tag is interrogated by light 1000 from a distant source. The interrogation light is brought to a focus on the focal surface (e.g., at point 1050), causing retroemission or retroreflection back in a direction antiparallel to light 1000. The retroemissive chemical or biological agent detector tag placed on surfaces in an area that is to be monitored for chemical or biological agents can be interrogated from a ****few hundred meters away. Alternative embodiments of an active RE tag or retroreflective device include a retroreflective device whose back focal plane is physically moved or electrically altered in response to a change in local environmental conditions such as temperature, aerosols, light intensity, gases, sounds, vibrations, wind, pH, etc. For example, the back focal plane can be a deformable reflective membrane or cantilever, whose deformation is electronically controlled by the output of a sensor. However, there are particular advantages to an active RE tag that does not require electrical power.

In another embodiment shown in FIG. 10B, the retroemissive chemical or biological agent detector tag may have the form of a cast lenslet array 1110 having a separate focal surface 1130 on a plate or film 1150 coated with retroemissive material 1130. The space between the lenslet array 1110 and the plate or film 1150 forms a chamber through which gas or liquid can flow (e.g., along paths 1140 and 1170), carrying chemical or biological agents from the environment into contact with the retroemissive material 1130 which is sensitive to the presence of the agent. Interrogation light 1100 passes through the lenslet surfaces (e.g., 1120) and focuses to a point (e.g., 1160) on the retroemissive layer 1130 behind each lenslet, to cause retro-emission in the direction antiparallel to light 1100.

In another embodiment shown in FIG. 10C, a spherical glass bead 1230 may have a retroemissive coating 1250 on one hemisphere, and the retroemissive material in the coating is sensitive to the presence of a chemical or biological agent. The retroemissive material may be spectrally coded to identify the particular chemical or biological agent to which it is designed to be sensitive, by selecting the particular mixture of retroemissive substances forming the retroemissive coating. Interrogation light 1200, incident at an angle 1220 to the symmetry axis 1210 of the partially coated bead, is focused by the uncoated surface of the bead to a point 1240 on the coated back surface of the bead, causing retroemission back in an antiparallel direction to light 1200. These beads 1230 can be simply scattered in area to be monitored, or may be applied to a surface or tag. Because of their random orientation, the beads can then be interrogated and read from any angle that allows direct line-of-sight. A large number of different beads, each color coded to allow detection of a specific chemical or biological agent, can thus allow remote monitoring of an area for changes in the concentration or presence/absence of any substance to which some of the beads are sensitive.

In another embodiment illustrated in FIG. 10D, a retroemissive substance detector may consist of a cast array of spherical lenslets 1300, the back surfaces of which are the focal surfaces of the lenslets. The back surfaces are coated with a light emissive material 1345 sensitive to the presence or absence of a specific class of chemicals or biological substances. The sensitive surface of the lenslet array is exposed to air or water, so that if the class of chemicals or biological substances is present in the air or water it will come into contact with the sensitive surface. The nature of the sensitivity of the surface coating is that the spectral emission, reflection or absorption properties of the coating varies according to the concentration of a particular class of substances in the immediate vicinity of the coating. Interrogation light 1310, 1320 from a distant source is focused by each lenslet to a point (e.g., 1350) on the lenslet's back surface, causing retro-emission or retro-reflection of light 1330 antiparallel to the interrogation light. The detector shown stands vertically on a stand 1360 and may be mounted on the ground, on equipment, on walls, etc.

A retroemissive material may be made sensitive to the presence of a chemical or biological agent through any of several approaches. For example, the presence of hydrogen affects the reflectivity and color of certain metallic thin films. Many kinds of molecules have been developed and are commercially available, whose fluorescence is enhanced or quenched in the presence of other particular molecules. Quantum dots' quantum efficiency and fluorescence lifetime are affected by the close proximity of any molecule to which energy can be transferred from the quantum dot.

The retroemissive tags of the technology may be used in many ways. For example, an RE tag can be used to identify individual livestock animals. An RE ear tag for livestock has the advantage of being interrogatable from all directions, essentially independently of the tag's orientation. A typical RFID tag with a single antenna, by contrast, can only be read if the antenna is in certain orientations with respect to an RFID reader.

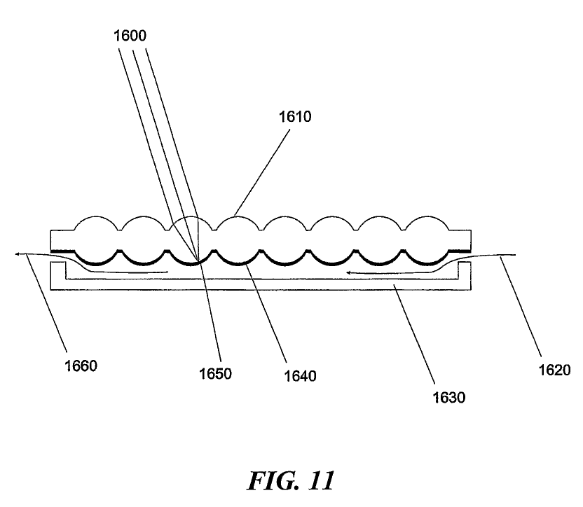

FIG. 11 illustrates a another example of the principle of the substance detectors discussed with respect to FIGS. 10A, 10B and 10C. In the substance detector of FIG. 11, instead of having only a light-emissive material coated on its focal surface 1640, the focal surface is coated with a substance having a binding affinity to a target substance. In addition to being exposed to a flow 1620, 1660 of gas or liquid that may be carrying the target substance, the coating on the focal surface is additionally or subsequently exposed to a fluorescent substance (or other light emissive substance) that binds preferentially to the target substance or to a complex of the target substance and the substance having a binding affinity to the target substance. Interrogation light 1600 is focused by the lenslets in array 1610 onto the coated focal surface 1640. If the target substance and light emissive substance are both present, the focal surface will retro-emit in response to the interrogation light 1600, thereby indicating the presence of the target substance.

U.S. Pat. No. 6,114,038 to Castro and Barbera-Guillem entitled “Functionalized nanocrystals and their use in detection systems” describes the use of functionalized fluorescent nanocrystals which, when complexed with a target substance, have an altered emission spectrum. That process is suitable for use in the embodiment of the present invention described in FIG. 11, to provide a light-emissive coating whose light emission characteristics are sensitive to the presence of a target substance.

Other processes that allow a target substance to alter the emission, absorption or reflection properties of a substance are described in: (1) Nanoscaled Science and Engineering for Sensing: Quantum Dots Fluorescence Quenching for Organic NO2 Sensing, S. Nieto, A. Santana, R. Delgado, S. P. Hernandez, R. T. Chamberlain, R. Lareau and M. E. Castro The University of Puerto Rico Chemical Imaging Center, US; (2) Fluorescent Quantum Dots for Biological Labeling (Fluorescence is effectively turned on by enzymes specific to cells of interest), Gene McDonald, Jay Nadeau, Kenneth Nealson, Michael Storrie-Lombardi, and Rohit Bhartia of Caltech of NASA's Jet Propulsion Laboratory http://www.nasatech.com/Briefs/Oct03/NPO30373.html; (3) Adaptation of inorganic quantum dots for stable molecular beacons, Joon Hyun Kim, Dimitrios Morikis, and Mihrimah Ozukan, Elsevier 10 Jun. 2004, http://www.molecular-beacons.org/DOWNLOAD/Kim,SA04(102)315.PDF.

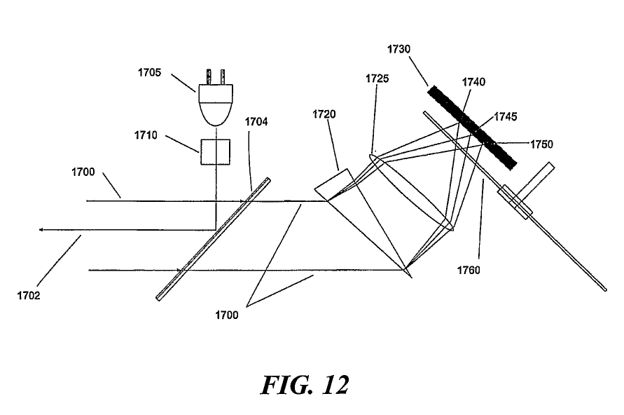

FIG. 12 illustrates an example of a detector or reader of retro-emissive and retro-reflective devices. It may be a camera with optics 1720, 1725 for spreading each point in the image into a spectrum 1740, 1745, 1750, with a gated photodetector array 1730 in the image plane, and with a modulatable light source 1705 and a modulator 1710. The light source 1705 is modulated at a convenient frequency unlikely to be found in the ambient illumination, such as 1300 Hz. Its light 1702 reflects off a dichroic beamsplitter 1704, travels to the retro-reflective devices and stimulates retro-emission 1700 which travels back and travels through the beamsplitter 1704. The retro-emitted light is dispersed spectrally by prism 1720 then imaged by lens 1725 onto the photodetector array 1730, forming a focused spectrum for each retro-emissive device imaged. FIG. 12 shows three colors 1750, 1745 and 1740 in the spread spectrum image from a single retro-emissive tag. In order to suppress ambient light in favor of retro-emitted light stimulated by light from the light source, the photodetector array is gated either electronically or with a shutter, to receive and detect light that is synchronous with the modulation of the light source. In this FIG. 12 the gating is accomplished by a chopper shown edge-on 1760. Thus, distant retro-emissive devices will be imaged relatively brightly compared to non retro-emissive objects in a scene, and the images will be spread into spectra. Alternatively, the retro-emissive devices may include a polarizer or other means to polarize the retro-emitted light, and the detector may include means to admit only light having the same polarization as the retro-emitted light. For example, element 1760 can be a polarizer instead of a chopper. An image-processing algorithm then extracts spectral information about each retro-emissive object in the scene by locating bright spots in the image and analyzing the portion of the image corresponding to the spread spectrum associated with each bright spot. Because the images of retroemissive devices that are separated sufficiently in the image plane that their spectra do not overlap can be individually analyzed, this detector or reader can simultaneously detect or read multiple retro-emissive devices within its angle of view.

In other embodiments of the technology, retroemissive beads of several different types (for example, types A, B and C, each having different retroemissive spectra) can be mixed together in a predetermined ratio and sprayed on an item to be marked, such as a truck, container, or individual person or group of items. If necessary to provide adhesion, the beads can be sprayed together with an adhesive substance. Then, the item can be detected and identified remotely by illuminating it with an interrogation beam and analyzing the retroemitted spectrum, which will be a substantially linear superposition of the retroemitted spectra of the types of beads according to the predetermined ratio. A suitable dispenser for a bead mixture would include several sub-dispensers (e.g., powder dispensers), each of which would dispense a fixed quantity of a suspension of a different type of retroemissive bead. The dispenser may blow the suspensions out from a nozzle, along with an adhesive aerosol to assure that the beads would stick to the item to be marked. The dispenser could dispense dry beads or beads suspended in water; and it could eject the beads electrostatically or by compressed air as appropriate to the application.

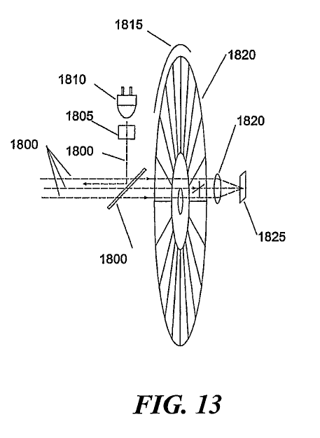

The RE tag reader in FIG. 13, for example, performs a similar function to the one in FIG. 12, one difference being that spectral information in the example shown in FIG. 13 is detected by filtering incoming retroemitted light through a variable narrow-bandpass wavelength filter 1820 and analyzing the differences between the images detected at each wavelength as the bandpass wavelength of the filter is varied. For example, the variable filter may be a “color wheel” 1820 containing bandpass interference filters arranged in a circle on a wheel that turns in front of the camera. The camera includes a lens 1830 and a photodetector array 1825. Light 1800 from the light source 1810 may be modulated by a modulator 1805. The light 1800 reflects off the beamsplitter 1840 to illuminate distant retroemissive devices. Retro-emitted light 1850 returns, passes through the beamsplitter 1840, passes through the filter wheel 1820, is focused by lens 1830 to form an image on the photodetector array 1825. Each of the segments of filter wheel 1820 is transmissive to a different narrow band of wavelengths of light. The photodetector array 1825 is electronically gated synchronously with the modulation imposed by modulator 1805 onto light 1800. For best results the modulation period should be longer than the emission decay lifetime of the retro-emissive material in the retroemissive devices and also longer than the time required for light to travel from the light source 1810 to the retroemissive devices and back to the detector array 1815. A processor (not shown) analyzes the image information from the detector array 1825 over the frames recorded during one rotation of the filter wheel in order to extract spectra for each of the retroemissive displays imaged onto the photodetector array 1825.

### Other Considerations

Typically when a retroreflective tag is interrogated, the interrogation beam will have a finite diameter, will be modulated at a finite frequency, and will move at a finite scan speed relative to the tag. The desired scan speed, the diameter of the laser and the speed of the detector electronics will constrain the choice of light emissive materials to be used in the tags. Preferably, the light emissive materials have fluorescence lifetimes or upconversion decay times in the range of ten nanoseconds to tens of microseconds.

1) Modulation Frequency of the Diode Laser

The modulation frequency is preferably, although not necessarily, within a factor of 10 of the inverse of the fluorescence lifetime in order to maximize measurement accuracy. A diode laser driver capable of modulation rates ranging from about 10 nanoseconds to tens of milliseconds may be used, for example. Fourier analysis of the detected signal can separate the effects of the various modulation frequencies and therefrom determine the fluorescence lifetimes of the materials in the tag

2) Angular Distribution of Return Beam

The retro-emission may be spread as little as possible to maximize signal strength, which will in turn maximize range and resolution. The angular distribution or spread of the return beam is a function of several variables including size and quality of the optics in the retro-emissive label, precision in maintaining thickness of the label, thickness of the fluorescent coating, scattering in the material of the label, absorption and re-emission of fluorescence light, shape and properties of the reflective surface at the back of the label, and so on.

The technology described above may be employed in at least the following systems: a search and rescue tag and system, a track-and-trace system, and an optical document security marking and reading system. In the search and rescue application, the technology offers a very low-cost tag and a scanner/seeker that can detect, locate and identify individual personnel and equipment on the ground from distances up to a kilometer away. In the optical document security printing and reading application, the technology offers a non-contact reader that can verify the authenticity of documents, ID cards and labels, and at the same time provide all the value of a bar code system or magnetic stripe system.

The term “quantum dot” as used here refers to any nanometer-sized (e.g., smaller than 25 nanometers but larger than an Angstrom) particle whose optical properties are strongly influenced by particle size and whose properties include absorption of light in one spectral distribution and subsequent emission of light with another spectral distribution. Thus, a fluorescent semiconductor nanocrystal whose fluorescent emission depends on its size is a quantum dot; and an upconversion nanoparticle (that is, a nanometer-scale particle that emits light at a photon energy higher than the excitation light's photon energy) whose behavior depends on its size is also a quantum dot.

The term “fluorescence” as used here refers to any process by which light is absorbed in one wavelength range then subsequently emitted at a longer wavelength by a material, molecule, atom, particle or substance. The time between absorption and emission may be dependent on the wavelength of emission, and is referred to as the fluorescence lifetime. Fluorescence lifetime is a probabilistic measure usually referring to the “half life” of the excited state of the fluorophore prior to emission.

“Light emissive” is used herein to refer to the property of a substance to emit light. The ability to emit fluorescence, Raman emission, Stokes and anti-Stokes emissions, upconverted light, downconverted light, and Raleigh scattered light are all forms of the “light emissive” property. The emitted light can be visible, ultraviolet, near infra-red, far infra-red, and so on.

The term “marking device” in this technology may refer to a label bearing retroemissive beads, to loose retroemissive beads, to single or multiple individual retroemissive beads, to retroemissive beads in a liquid or solid, to retroemissive beads suspended in the air or in an aerosol, to retroemissive beads in orbit or falling through the atmosphere, or to any device containing retroemissive beads for remote or nearby detection and identification, track & trace, verification, authentication, document security, or like purposes. The retroemissive beads can be positioned in predetermined patterns or in random arrangements of beads having predetermined properties; and either or both the predetermined patterns and the properties of individual beads or groups of beads can be selected to encode information. Similarly the random arrangement of beads and their properties can be associated with an individual item to provide a unique identifier for that item.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description describes certain embodiments of the invention, and describes the best mode contemplated, no matter how detailed the above appears in text, the invention can be practiced in many ways. Details of the data collection and processing system may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I/We claim:

1. A marking device, comprising:
means for receiving light from a source;
means for focusing the light to multiple points on a surface;
means for emitting light from the points positioned on a focal plane of the means for focusing; and
means for collimating light emitted from the points into multiple beams directed back toward the source, wherein the light emitted from the points conveys information regarding at least an identity, a condition, a history, an orientation, or an environment of the marking device.

2. The marking device of claim 1, wherein the means for emitting comprises a layer of light emissive material having a property of emitting light of a second spectral content in response to receiving the light from the source, the light from the source having a first spectral content different from the second spectral content.

3. The marking device of claim 2, wherein the light emissive material comprises at least one of fluorescent dyes, fluorescent powders, upconversion materials, luminescent quantum dots, Raman spectrum emitters, Stokes emitters, or anti-Stokes emitters.

4. The marking device of claim 2, wherein the light emissive material comprises at least two of fluorescent dyes, fluorescent powders, upconversion materials, luminescent quantum dots, Raman spectrum emitters, Stokes emitters, or anti-Stokes emitters.

5. The marking device of claim 4, wherein a quantity of each of the at least two light emissive materials encodes information.

6. The marking device of claim 2, wherein the layer of light emissive material is of a thickness chosen to provide a certain angular distribution of retroemitted light.

7. The marking device of claim 2, wherein the light emissive material is positioned at different sections of the focal plane and has different emission spectra relative to the section.

8. The marking device of claim 7, wherein the arrangement of the sections and the emission spectra encodes at least a portion of information content.

9. The marking device of claim 8, wherein a total spectral content of the emitted light encodes at least the portion of the information.

10. The marking device of claim 2, the means for emitting further comprising a reflective layer adjacent to the layer of light emissive material.

11. The marking device of claim 2, wherein the marking device is attached to a selected entity and the second spectral content provides identification information about the selected entity.

12. A system comprising,
an interrogation light source;
a marking device, the marking device configured to retro-emit light in response to receiving interrogation light transmitted from the interrogation light source; and
a retro-emitted light detector and analyzer proximate to the interrogation light source.

13. The system of claim 12, wherein the marking device comprises fluorescent dyes, fluorescent powders, upconversion materials, luminescent quantum dots, Raman spectrum emitters, Stokes emitters, or anti-Stokes emitters.

14. A method of determining a presence of a selected analyte in a selected environment, comprising:
transmitting light of a first spectral content from a light source to a device located in the selected environment, wherein the device is configured to receive the transmitted light and emit light of a different spectral content in the direction of the light source;
emitting light from the device towards the light source, wherein the device emits light of a second spectral content when the device is not in contact with the selected analyte and emits light of a third spectral content when the device is in contact with the selected analyte; and
detecting the spectral content of the emitted light.

15. A detector of retroemissive devices in a scene, comprising:
imaging optics configured to form a spectrally spread image of the scene containing the retroemissive devices,
a modulatable light source configured to illuminate the scene with modulated light,
a photodetector array positioned to receive the spectrally spread image of the scene,
a gating subsystem configured to selectively detect retro-emitted light from the retroemissive devices synchronously with the modulation of the light from the modulatable light source, and
an image processor configured to locate images of the retroemissive devices in the image and configured to analyze a spread spectrum associated with images of the retroemissive devices in the image of the scene.

16. A method of forming a mixture of retroemissive beads, comprising:
determining information to be encoded by the mixture;
selecting beads of a first spectral content;
selecting beads of a second spectral content; and
collectively dispensing a first specific quantity of the beads of a first spectral content with dispensing a second specific quantity of the beads of the second spectral content in order to form a mixture;
wherein the first spectral content, the second spectral content, and the first and second specific quantities are selected based on information to be encoded.

17. The method of claim 16, further comprising:
dispensing an adhesive along with collectively dispensing the beads of the first spectral content and the beads of the second spectral content.

18. An article of manufacture, comprising:
a first portion that receives incoming light of a first spectral content from a source;
a second portion proximate to the first portion that focuses the incoming light to multiple points on a surface portion located on a focal plane of the second portion;
a third portion on the surface portion for emitting light of a second spectral content when the multiple points receive the incoming light; and
a fourth portion proximate to the surface portion that collimates the emitted light into multiple beams directed back towards the source.

19. The article of manufacture of claim 18, further comprising:
light emissive material positioned at different sections of the third portion, each section containing light emissive material that emits light of a unique emission spectrum relative to the other sections;
wherein the arrangement of the sections encodes at least a portion of information and wherein further a total spectral content of emitted light encodes at least a portion of information.

20. The article of manufacture of claim 18, wherein the light emissive material comprises at least one of fluorescent dyes, fluorescent powders, upconversion materials, luminescent quantum dots, Raman spectrum emitters, Stokes emitters, or anti-Stokes emitters.

21. The article of manufacture of claim 18, wherein the light emissive material comprises at least two of fluorescent dyes, fluorescent powders, upconversion materials, luminescent quantum dots, Raman spectrum emitters, Stokes emitters, or anti-Stokes emitters.

22. The article of manufacture of claim 18, wherein the light emissive material comprises at least two of fluorescent dyes, fluorescent powders, upconversion materials, luminescent quantum dots, Raman spectrum emitters, Stokes emitters, or anti-Stokes emitters and wherein further a quantity of each of the at least two light emissive materials encodes information.

23. The article of manufacture of claim 18, wherein the layer of light emissive material is of a thickness chosen to provide a certain angular distribution of emitted light.

24. The article of manufacture of claim 18, further comprising:
a reflective portion adjacent to the third portion.

25. The article of manufacture of claim 18, wherein the article is attached to a selected entity and the second spectral content provides identification information about the selected entity.
